(19) United States
(12) Patent Application Publication
(10) Pub. No.: US 2025/0045785 A1
(43) Pub. Date: Feb. 6, 2025

(54) COMPUTER-READABLE RECORDING MEDIUM STORING GENERATION PROGRAM, GENERATION METHOD, AND INFORMATION PROCESSING DEVICE

(71) Applicant: Fujitsu Limited, Kawasaki-shi (JP)

(72) Inventor: Takashi YAMAZAKI, Kawasaki (JP)

(73) Assignee: Fujitsu Limited, Kawasaki-shi (JP)

(21) Appl. No.: 18/782,442

(22) Filed: Jul. 24, 2024

(30) Foreign Application Priority Data
Aug. 2, 2023 (JP) 2023-125994

(51) Int. Cl. G06Q 30/0204

(52) U.S. Cl. CPC G06Q 30/0205

(57) ABSTRACT

A non-transitory computer-readable recording medium stores a generation program for causing a computer to execute processing including: setting a weight to each combination of product categories of purchased products, based on sales information of a product; and generating visualized information that visualizes and indicates a behavior history of a user that corresponds to the sales information, by combining basis visualized information that visualizes and indicates a behavior history of the user in a store, for each of a plurality of purchase patterns that has different combinations of the product categories of the purchased products, stored in a memory, based on the set weight.

### CROSS-REFERENCE TO RELATED APPLICATION

This application is based upon and claims the benefit of priority of the prior Japanese Patent Application No. 2023-125994, filed on Aug. 2, 2023, the entire contents of which are incorporated herein by reference.

### FIELD

The embodiment discussed herein is related to a generation program, a generation method, and an information processing device.

### BACKGROUND

Typically, in a marketing field of retail stores such as supermarkets or convenience stores, there is a related art for generating a heatmap in which an accumulated stay time of a user at each point in a store is displayed to be overlapped on a store map. This heatmap is a visualization and analysis tool that analyzes a human flow or traffic line of the user (hereinafter, traffic line analysis) and is very useful for analysis for the purpose of improving an efficiency in the store such as alleviating congestion or improving an access or sales.

U.S. Patent Application Publication No. 2016/0253740 is disclosed as related art.

### SUMMARY

According to an aspect of the embodiments, a non-transitory computer-readable recording medium stores a generation program for causing a computer to execute processing including: setting a weight to each combination of product categories of purchased products, based on sales information of a product; and generating visualized information that visualizes and indicates a behavior history of a user that corresponds to the sales information, by combining basis visualized information that visualizes and indicates a behavior history of the user in a store, for each of a plurality of purchase patterns that has different combinations of the product categories of the purchased products, stored in a memory, based on the set weight.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an information processing device according to an embodiment;

FIG. 2 is an explanatory diagram for explaining a store layout example;

FIG. 3 is an explanatory diagram for explaining an example of POS data;

FIG. 4 is a flowchart illustrating an example of basis map generation processing;

FIG. 5 is an explanatory diagram for explaining an example of a basis map;

FIG. 6A is a flowchart (1) illustrating a processing example of heatmap generation by the information processing device according to the embodiment;

FIG. 6B is a flowchart (2) illustrating a processing example of the heatmap generation by the information processing device according to the embodiment;

FIG. 7 is an explanatory diagram illustrating an example of a receipt appearing in the POS data;

FIG. 8 is an explanatory diagram illustrating an example of a histogram;

FIG. 9 is an explanatory diagram illustrating an example of the generated heatmap; and

FIG. 10 is an explanatory diagram for explaining an example of a computer configuration.

### DESCRIPTION OF EMBODIMENTS

However, the related art described above has a problem in that generation of a heatmap requires a large amount of cost and it is difficult to perform traffic line analysis of a user at low cost.

For example, in a case where the heatmap is created by measuring an actual movement of the user, it is necessary to prepare equipment for specifying coordinates of the user in a store at each time based on measurement using a radio wave communication technology or a captured image by a camera that can observe an entire area in the store.

Furthermore, in a case where the heatmap is generated by simulatively simulating a movement of the user in the store by agent simulation based on point of sale (POS) data, each user included in the POS data is simulated by an agent. Therefore, large calculation cost is caused. Furthermore, in a retail store of which customer segments are different for each time band including morning, daytime, and night, in order to perform traffic line analysis for each time band, a plurality of heatmaps corresponding to the respective time bands is generated. Therefore, a calculation time becomes longer because the agent simulation is performed for each time band based on the POS data collected for each time band.

In one aspect, an object is to provide a generation program, a generation method, and an information processing device that enable to perform traffic line analysis of a user in a store at low cost.

Hereinafter, a generation program, a generation method, and an information processing device according to an embodiment will be described with reference to the drawings. The configurations having the same function in the embodiment are denoted with the same reference sign, and the redundant description will be omitted. Note that the generation program, the generation method, and the information processing device to be described in the following embodiment merely indicate examples and do not limit the embodiment. Furthermore, each embodiment below may be appropriately combined within the scope of no contradiction.

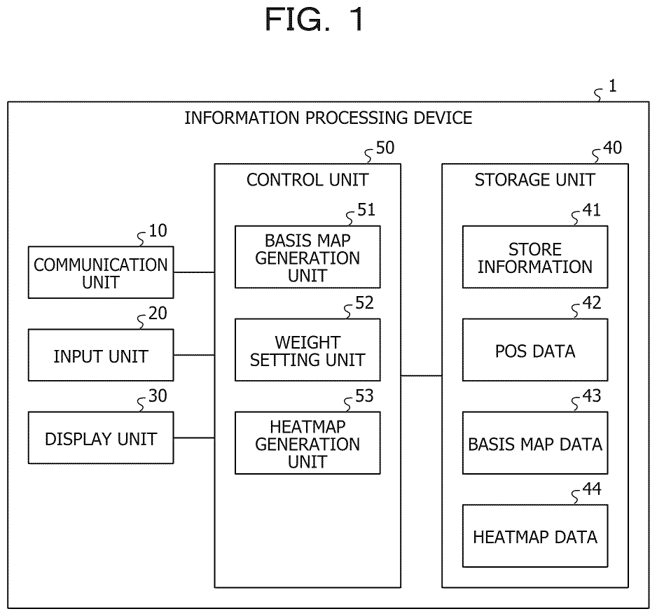

FIG. 1 is a block diagram illustrating an exemplary functional configuration of the information processing device according to the embodiment. As illustrated in FIG. 1, an information processing device 1 includes a communication unit 10, an input unit 20, a display unit 30, a storage unit 40, and a control unit 50. As the information processing device 1, for example, a personal computer (PC) or the like can be applied. The information processing device 1 generates visualized information such as a heatmap visualizing and indicating a behavior history of a user who has purchased a product in a store indicated by POS data 42, based on sales information (POS data 42) of the product in the store.

The communication unit 10 performs data communication with an external device or the like via a network. For example, under control by the control unit 50, the communication unit 10 acquires store information 41 regarding the store, the POS data 42 regarding sales of the products in the store, or the like by a server device that manages data in the store or the like. The communication unit 10 stores the acquired store information 41 and POS data 42 in the storage unit 40.

The input unit 20 receives an operation from the user. For example, the input unit 20 receives an instruction for correcting the store information 41 in accordance with layout change in the store (for example, change in product display position) from the user. Based on this correction instruction, the store information 41 is corrected to content according to the layout change.

The display unit 30 displays a processing result of the control unit 50. For example, the display unit 30 displays the visualized information such as the heatmap generated by the control unit 50 on a display.

The storage unit 40 includes the store information 41, the POS data 42, basis map data 43, and heatmap data 44. For example, the storage unit 40 is implemented by a memory or the like.

The store information 41 is information indicating a layout of a store or the like. For example, the store information 41 includes map (position) information such as an entrance for the user in the store, a passage where product display shelves are arranged, or a cash register. Furthermore, the store information 41 includes information indicating a product display position for each product category (ice creams and bread, confectionery, sweets, instant food, non-food products, or the like) in the store.

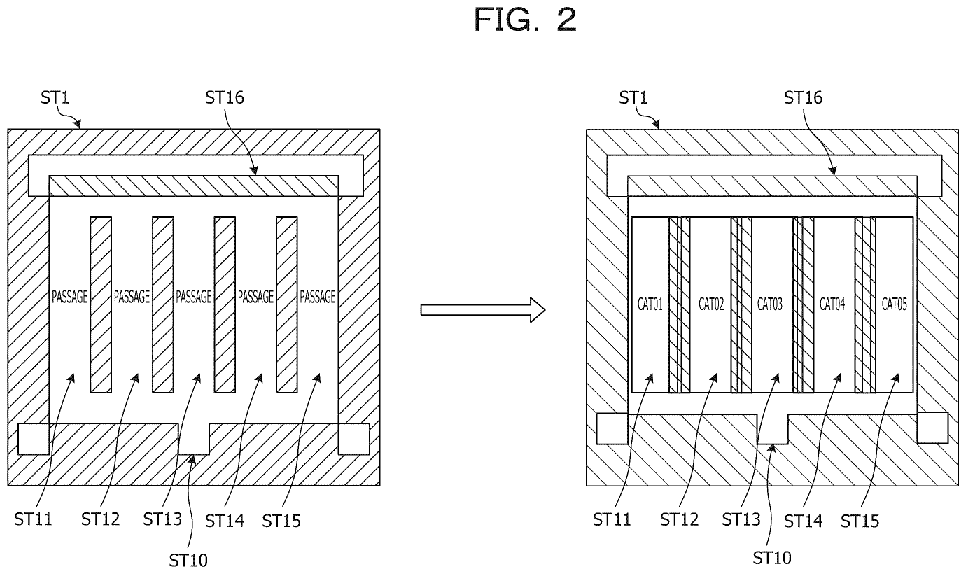

FIG. 2 is an explanatory diagram for explaining a store layout example. For example, in FIG. 2, an example of a planar layout of a store ST1 to be a target of traffic line analysis of the user is illustrated.

As illustrated in FIG. 2, the store ST1 has a layout from an entrance ST10 to a cash register ST16 through passages ST11 to ST15 where the product display shelves are arranged. The store information 41 includes map information indicating such a layout of the store ST1.

Furthermore, the store information 41 includes information regarding products arranged on the display shelves on the respective passages ST11 to ST15 and product categories CAT01 to CAT05 corresponding the products. For example, in a case where the product category CAT01 is ice creams and bread, it is found that the ice creams and bread are arranged on the display shelf on the passage ST11, from the store information 41. Furthermore, in a case where the product category CAT02 is confectionery, it is found that the confectionery is arranged on the display shelf on the passage ST12, from the store information 41. Furthermore, in a case where the product category CAT03 is sweets, it is found that the sweets are arranged on the display shelf on the passage ST13, from the store information 41. Furthermore, in a case where the product category CAT04 is non-food products, it is found that the non-food products are arranged on the display shelf on the passage ST14, from the store information 41. Furthermore, in a case where the product category CAT05 is instant food, it is found that the instant food is arranged on the display shelf on the passage ST15, from the store information 41.

It is assumed that the information regarding the product categories CAT01 to CAT05 of the products arranged on the display shelves on the respective passages ST11 to ST15 be updated by the user of the information processing device 1 at a timing when arrangement of the products is changed.

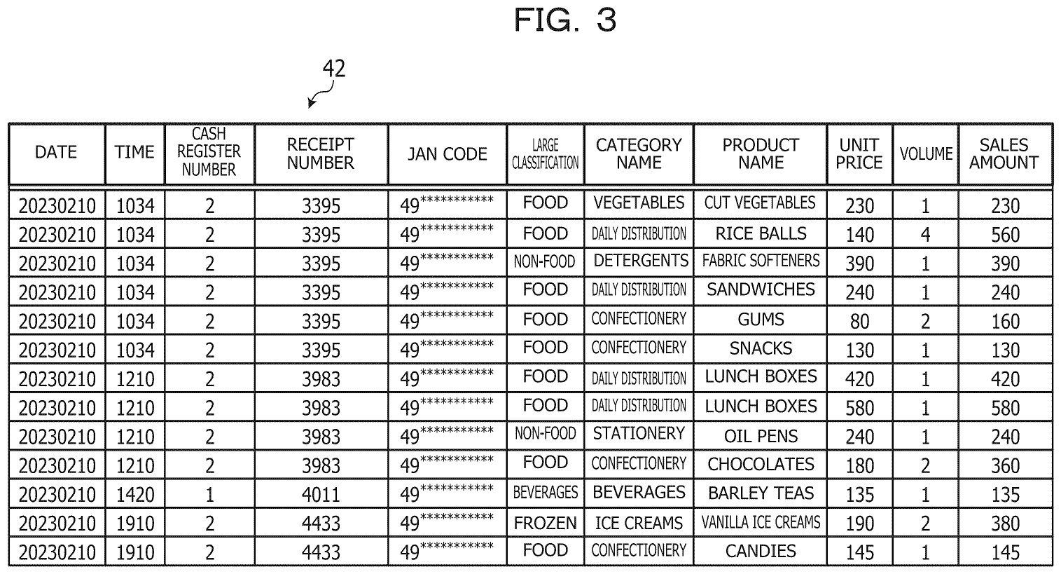

Returning to FIG. 1, the POS data 42 is an example of sales information indicating sales of the products in the store ST1. FIG. 3 is an explanatory diagram for explaining an example of the POS data 42.

As illustrated in FIG. 3, the POS data 42 stores information for each product sales. For example, the POS data 42 includes information such as a “date”, a “time”, a “cash register number”, a “receipt number”, a “JAN code”, a “large classification”, a “category name”, a “product name”, a “unit price”, a “volume”, a “sales amount”, or the like, for each sale. The JAN code is a common product code used in Japan and is an abbreviation for Japanese Article Number code. It is equivalent to EAN code (European Article Number code) in Europe and the UPC (Universal Product Code) in the United States and Canada. In the following, whenever JAN is written in this document or figures, read it as EAN or UPC depending on the reader.

The “date” indicates a date of the sales. The “time” indicates a time of the sales. The “cash register number” indicates an identification number of the cash register ST16 that has recorded the sales. The “receipt number” indicates an identification number of a receipt that has recorded the sales. For example, six pieces of sales data of which a “receipt number” is “3395” in the illustrated example indicate sales registered in one receipt identified by the number.

The “JAN code” indicates a Japanese article number (JAN) used to identify a product of which the sales have been recorded. The “large classification” indicates a large classification (for example, food, non-food, beverages, frozen, or the like) of the product of which the sales has been recorded. The “category name” indicates a category (vegetables, daily distribution, detergents, confectionery, or the like) of the product of which the sales have been recorded. The “product name” indicates a name of the product of which the sales have been recorded. The “unit price” indicates a unit price of the product of which the sales have been recorded. The “volume” indicates a volume of the product of which the sales have been recorded. The “sales amount” indicates an amount of the sales.

Returning to FIG. 1, the basis map data 43 is information that visualizes and indicates a behavior history of the user in the store ST1, for each of a plurality of purchase patterns having different combinations of the product categories CAT01 to CAT05 of the purchased products. For example, the basis map data 43 includes a heatmap (basis map) that superimposes the behavior history of the user in a planar map of the store ST1, for each of the plurality of purchase patterns (basis) and represents a crude density of an accumulated stay time of the user by shading. For example, the basis map data 43 is an example of basis visualized information.

The heatmap data 44 is data regarding a heatmap that visualizes and indicates a behavior history of the user corresponding to the POS data 42. For example, the heatmap data 44 is an example of the visualized information.

For example, the heatmap data 44 is the data of the heatmap generated by combining basis maps included in the basis map data 43, based on the POS data 42 (details will be described later).

The control unit 50 includes a basis map generation unit 51, a weight setting unit 52, and a heatmap generation unit 53. For example, the control unit 50 is implemented by a processor.

The basis map generation unit 51 is a processing unit that generates the heatmap (basis map) visualizing the behavior history of the user in the store ST1, for each of the plurality of purchase patterns (basis) having different combinations of the product categories of the purchased products, based on the store information 41 indicating the arrangement in the store for each product category.

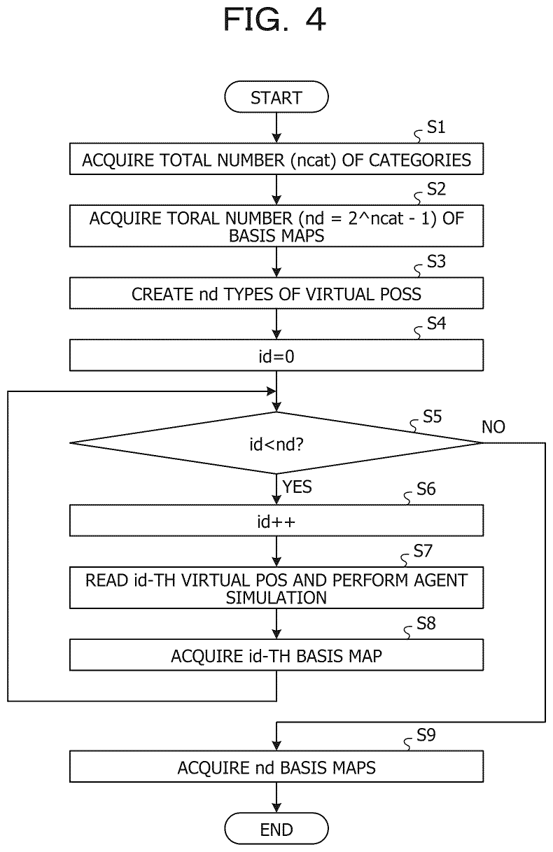

FIG. 4 is a flowchart illustrating an example of basis map generation processing. As illustrated in FIG. 4, the basis map generation unit 51 acquires the store information 41 regarding the store ST1. As a result, the basis map generation unit 51 acquires the position of the cash register ST16 in the store ST1, the positions of the passages ST11 to ST15 (display shelf), the products arranged on the display shelves on the passages ST11 to ST15, and the product categories CAT01 to CAT05. Next, the basis map generation unit 51 acquires a total number (ncat) of the product categories CAT01 to CAT05 from the store information 41 (S1).

Next, the basis map generation unit 51 acquires a total number (nd=2\hat{ }ncat−1) of the basis maps, based on the total number (ncat) of the product categories CAT01 to CAT05 (S2). For example, in a case where the total number (ncat) of the product categories CAT01 to CAT05 is five, the total number of the basis maps is nd=2\hat{ }5−1=31. For example, in S2, the basis map generation unit 51 obtains the total number (nd) of the plurality of purchase patterns having the different combinations of the product categories.

Next, the basis map generation unit 51 creates nd types of virtual POSs, corresponding to the plurality of purchase patterns having the different combinations of the product categories (S3).

For example, the basis map generation unit 51 creates the virtual POSs corresponding to the purchase patterns from a combination for visiting one product category (purchase product in product category) to a combination for finally visiting ncat product categories in order.

For example, first, the basis map generation unit 51 creates ncat POSs for visiting the one product category (purchase product in product category) among the product categories CAT01 to CAT05 (visiting probability is one). Similarly, the basis map generation unit 51 creates _{ncat}C₂ POSs for visiting the two product categories among the product categories CAT01 to CAT05 (each visiting probability is ½). Thereafter, the basis map generation unit 51 creates _{ncat}Ck POSs for visiting k product categories among the product categories CAT01 to CAT05 (each visiting probability is 1/k). Finally, the basis map generation unit 51 creates _{ncat}C_{ncat} POSs for visiting the ncat product categories among the product categories CAT01 to CAT05 (each visiting probability is 1/ncat).

Next, the basis map generation unit 51 performs initialization while setting a processing number (id) as id=0 (S4) and determines whether or not id<nd (S5).

In a case where id<nd (S5: Yes), the basis map generation unit 51 increments id (S6). Next, the basis map generation unit 51 reads an id-th virtual POS and performs agent simulation based on the virtual POS (S7). For example, the basis map generation unit 51 performs known agent simulation on the assumption of passing through the product category of the product to be visited (purchased) in the virtual POS.

Next, the basis map generation unit 51 acquires an id-th basis map based on the result of the agent simulation in S7 (S8) and returns the processing to S5.

In a case where id<nd is not satisfied (S5: No), the basis map generation unit 51 acquires nd basis maps by repeating S5 to S8 (S9). Next, the basis map generation unit 51 stores the acquired basis maps in the basis map data 43 together with identification information (id) indicating a combination of the visited product categories and ends the processing.

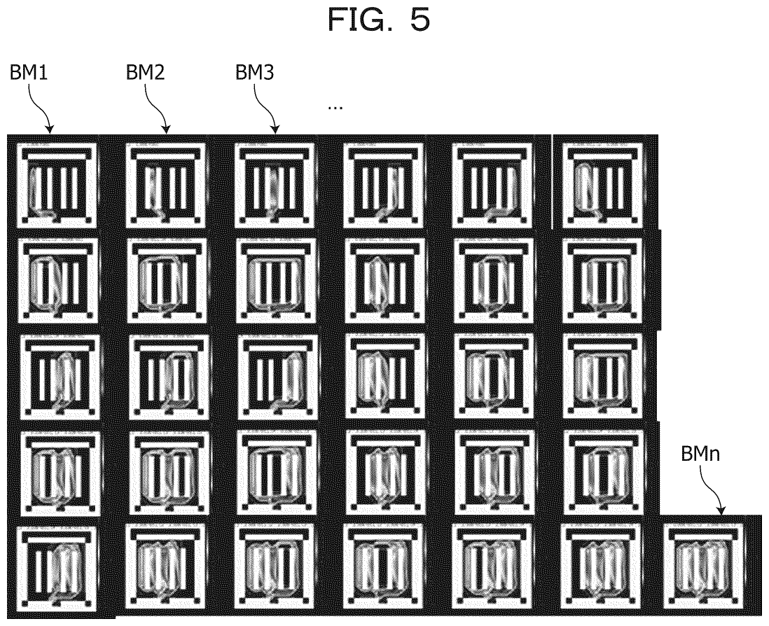

FIG. 5 is an explanatory diagram for explaining an example of the basis map. As illustrated in FIG. 5, the basis map generation unit 51 generates basis maps BM1, BM2, BM3, . . . , and BMn by the agent simulation, for the plurality of purchase patterns having the different combinations of the product categories CAT01 to CAT05. Next, the basis map generation unit 51 assigns the identification information indicating the purchase pattern (combination of product categories) for each of the generated basis maps BM1, BM2, BM3, . . . , and BMn, and then, stores the basis maps in the basis map data 43.

It is sufficient to generate the basis map data 43 by the basis map generation unit 51 described above once at the time when the product layout (product category corresponding to display shelf) in the store information 41 is updated. For example, the information processing device 1 can reuse the basis map data 43 generated once, if the product layout in the store ST1 is not updated.

Returning to FIG. 1, the weight setting unit 52 is a processing unit that sets a weight corresponding to each combination of the product categories of the purchased products, based on the POS data 42.

The heatmap generation unit 53 is a processing unit that combines the basis maps BM1, BM2, BM3, . . . , and BMn included in the basis map data 43 based on the weight set by the weight setting unit 52 and generates the heatmap data 44 that visualizes and indicates the behavior history of the user corresponding to the POS data 42.

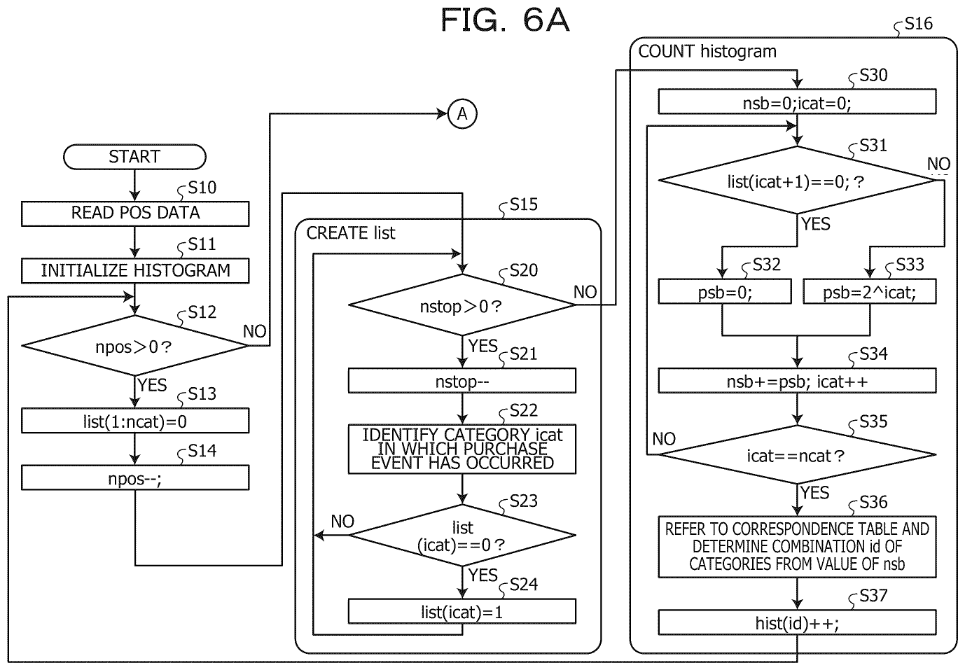

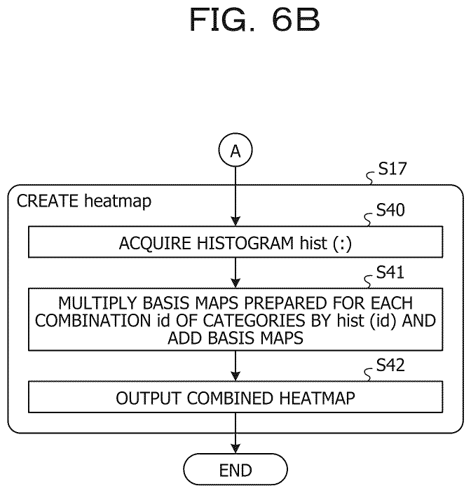

Here, processing of the weight setting unit 52 and the heatmap generation unit 53 will be described in detail. FIGS. 6A and 6B are flowcharts illustrating a processing example of the heatmap generation by the information processing device 1 according to the embodiment.

As illustrated in FIGS. 6A and 6B, when the processing is started, the weight setting unit 52 reads the POS data 42 (S10). Here, in a case of generating a heatmap regarding a predetermined time band (morning (6:00 to 10:00), daytime (10:00 to 18:00), and night (18:00 to 22:00)), it is assumed that the weight setting unit 52 read POS data 42 in the corresponding time band.

For example, in a case where the heatmap regarding the daytime (10:00 to 18:00) is generated, in the example in FIG. 3, sales data of which “receipt numbers” are “3395”, “3983”, and “4011” is read. Next, in a case where the heatmap regarding the night (18:00 to 22:00) is generated, in the example in FIG. 3, sales data of which a “receipt number” is “4433” is read.

Here, the weight setting unit 52 sets the number of receipts included in the POS data 42 as npos, for the read POS data 42. For example, in a case where the POS data 42 corresponding to the time band of the daytime (10:00 to 18:00) is read, there are three “receipt numbers” of “3395”, “3983”, and “4011”. Therefore, npos=3. Furthermore, the weight setting unit 52 sets the number of types of purchased products (the number of product categories) written in each receipt, for example, the number of times when the user has stopped as nstop. Furthermore, the weight setting unit 52 sets a product category associated with each purchased product as icat.

Next, the weight setting unit 52 initializes the weight (histogram) for each combination of the product categories of the purchased products (S11). For example, the weight setting unit 52 sets the above histogram as hist (id), that is, a function that can be referred by hist (1), hist (2), . . . , and hist (nd). As described above, id is the identification information indicating the combination of the product categories, and nd is the number of types of combinations. The weight setting unit 52 initializes this hist (id) as hist (1:nd)=0.

Next, the weight setting unit 52 determines whether or not npos>0 (S12). The number of receipts in first processing for reading the POS first is npos, and a value of the npos is decremented each time when a single receipt is processed, in the subsequent processing (S14). Therefore, by continuing the processing while the value of npos is positive, it is possible to execute the processing on all the receipts. Then, in a case where npos>0 is not satisfied (S12: No), all the receipts have been processed (weighted). Therefore, the weight setting unit 52 proceeds the processing to S17.

In a case where npos>0 (S12: Yes), the weight setting unit 52 creates a list (list array) in which the visited categories are not overlapped, for each receipt. This list array is an integer array, and it is assumed that a size be ncat. Here, the weight setting unit 52 sets list (1:ncat)=0 and initializes all the values in the list array to zero (S13). Next, the weight setting unit 52 decreases the value of npos by one (S14) and executes processing for creating the list (S15).

In the list creation processing, the weight setting unit 52 determines whether or not the number of stoppages nstop of the user read from each receipt satisfies nstop>0 (S20). The number of stoppages is nstop in the first processing, and in the subsequent processing (S21), the value of nstop is decremented each time when the product is processed. Therefore, by continuing the processing while the value of nstop is positive, it is possible to execute the processing on all the products on the receipt. In a case where nstop>0 is not satisfied (S20: No), since the processing on all the products on the receipt has been completed, the weight setting unit 52 proceeds the processing to S16.

In a case where nstop>0 (S20: Yes), the weight setting unit 52 identifies a category icat in which a purchase event (purchased product written in receipt) has occurred (S22).

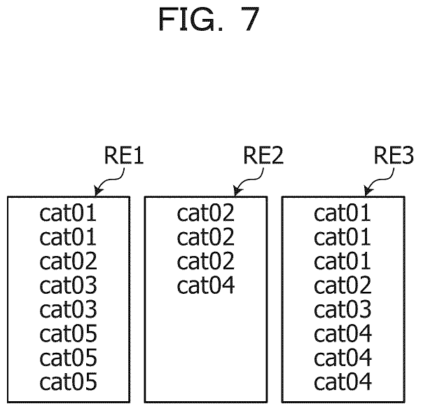

FIG. 7 is an explanatory diagram illustrating an example of the receipt appearing in the POS data. As illustrated in FIG. 7, it is assumed that receipts RE1, RE2, and RE3 be read from the POS data 42. The weight setting unit 52 identifies the category icat in which the purchase event (purchased product written in receipt) has occurred, for each of the receipts RE1, RE2, and RE3. For example, cat02, cat02, cat02, and cat04 are identified from the receipt RE2.

Next, the weight setting unit 52 determines whether or not list (icat)=0 (S23), and in a case where list (icat)=0 (S23: Yes), the weight setting unit 52 sets list (icat)=1 (S24) and returns the processing to S20. In a case where list (icat)=0 is not satisfied (S23: No), the weight setting unit 52 returns the processing to S20 without performing S24.

As a result, the weight setting unit 52 can set a flag of list (icat)=1 only for the product category that has stopped and shopped. For example, the weight setting unit 52 obtains a list (list array) of the visited product categories in each receipt in the POS data 42.

After such list creation, the weight setting unit 52 counts the weight (histogram) for each combination of the product categories of the purchased products, based on the list (S16).

For example, the weight setting unit 52 performs the following addition. nsb=sum_{1≤id≤nd} list (id)*2\hat{ }(id−1)

For example, in a case where list (1)=1, list (2)=1, list (3)=1, list (4)=0, and list (5)=1, nsb has the following value. nsb=1*2\hat{ }0+1*2\hat{ }+1+1*2\hat{ }2+0*2\hat{ }(3)+1*2\hat{ }4=1+2+4+0+16=23

The numerical value nsb obtained in this way takes all integer values from one to nd one by one. Therefore, the weight setting unit 52 can search for id using this value.

For example, the weight setting unit 52 performs initialization as setting nsb=0; icat=0 (S30).

Next, the weight setting unit 52 determines whether or not list (icat+1)=0 (S31). In a case where list (icat+1)=0 (S31: Yes), the weight setting unit 52 sets pbs=0 (S32) and proceeds the processing to S34. In a case where list (icat+1)=0 is not satisfied (S31: No), the weight setting unit 52 sets pbs=2\hat{ }icat (S33) and proceeds the processing to S34. In S34, the weight setting unit 52 sets nsb+=psb; icat++. In this way, the weight setting unit 52 adds nsb.

Next, the weight setting unit 52 determines whether or not icat=ncat (S35), and in a case of negative determination (No), the weight setting unit 52 returns the processing to S31.

In a case of positive determination (Yes) in S35, the weight setting unit 52 refers to a correspondence table of nsb and id and determines a combination id of the product categories from the value of the nsb (S36). Next, since the combination id of the product categories is determined, the weight setting unit 52 adds a count to the histogram as setting hist (id)++(S37) and returns the processing to S12.

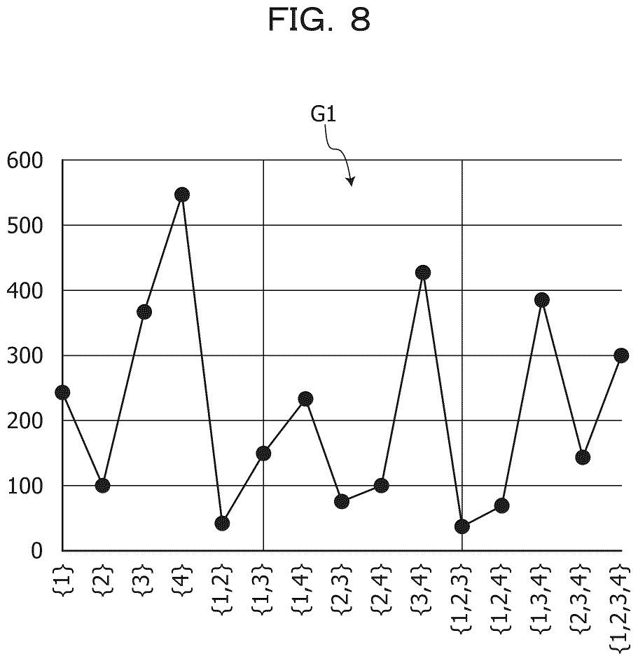

FIG. 8 is an explanatory diagram illustrating an example of the histogram. By counting as setting hist (id)++, as illustrated in FIG. 8, a histogram G1 for each of combinations {1}, {2}, . . . , {1, 2, 3, 4} of product categories (1 to 4) can be obtained.

In S17 after all the receipts have been processed (weighted), the heatmap generation unit 53 combines the basis maps BM1, BM2, . . . , and BMn included in the basis map data 43 based on the weight set by the weight setting unit 52 and creates the heatmap.

For example, the heatmap generation unit 53 acquires a histogram hist (:) (S40). Next, the heatmap generation unit 53 multiplies the basis maps BM1, BM2, . . . , and BMn prepared for each combination id of the product categories by hist (id) and adds the basis maps (S41). Next, the heatmap generation unit 53 outputs the heatmap combined by the addition in S41 as the heatmap data 44 (S42) and ends the processing.

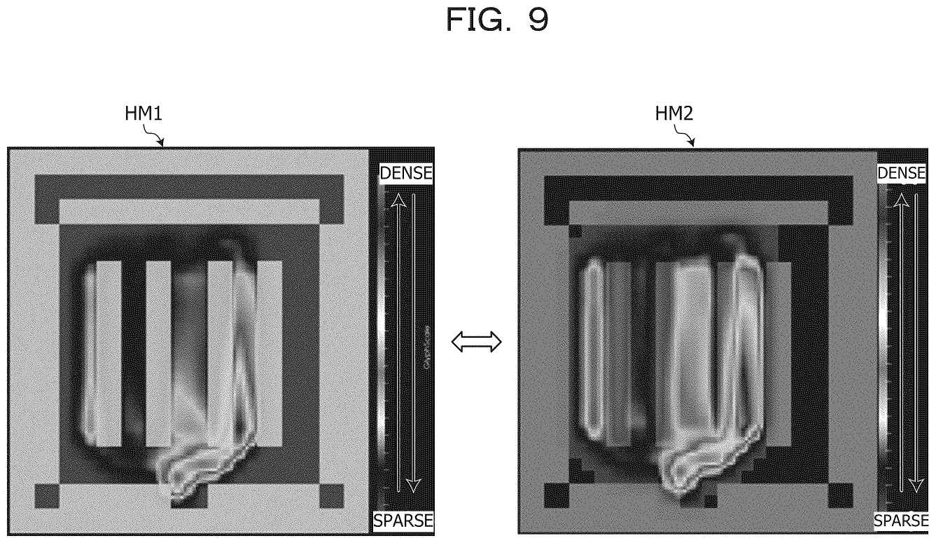

FIG. 9 is an explanatory diagram illustrating an example of the generated heatmap. In FIG. 9, a heatmap HM1 is a heatmap generated by the information processing device 1 based on the POS data 42. A heatmap HM2 is a heatmap obtained by measuring an actual movement of the user when the POS data 42 is obtained, for example, a heatmap based on an actual measured value.

As illustrated in FIG. 9, the heatmap HM1 generated by the information processing device 1 is substantially the same as the heatmap HM2 based on the actual measured value, and it is found that an accurate result is obtained.

It can be said this is because, for the output of the heatmap, an influence of an interaction between agents is small, and superposition of the basis maps BM1, BM2, . . . , and BMn is effective.

For example, the interaction of the users in the store ST1 includes waiting for a cash register, waiting, congestion, avoiding passing, or the like. However, a case where such an interaction occurs is very rare in practice. As an example, the waiting and the congestion occur at an extremely limited time within business hours, and an interaction in such a short time can be sufficiently ignored. Therefore, the heatmap HM1 generated by combining the basis maps BM1, BM2, . . . , and BMn based on the weight based on the POS data 42 accurately expresses a human flow.

As described above, the information processing device 1 sets the weight to each combination of the product categories of the purchased products, based on the POS data 42. The information processing device 1 combines, based on the set weight, the basis maps BM1, BM2, . . . , and BMn that visualize and indicate the behavior history of the user in the store ST1, for each of the plurality of purchase patterns having the different combinations of the product categories of the purchased products, stored in the storage unit 40. By combining the basis maps BM1, BM2, . . . , and BMn, the information processing device 1 generates the heatmap HM1 that visualizes and indicates the behavior history of the user corresponding to the POS data 42.

As a result, the information processing device 1 can obtain the heatmap HM1 that visualizes and indicates the behavior history of the user corresponding to the POS data 42, without measuring the movement of the user in the store ST1 or reproducing the movement of the user by the agent simulation. Therefore, the information processing device 1 can perform the traffic line analysis of the user in the store ST1 at low cost.

Furthermore, the information processing device 1 simulates the movement of the agent corresponding to the user in the store, for each of the plurality of purchase patterns, based on the store information 41 indicating the arrangement in the store for each product category and generates the basis maps BM1, BM1, BM2, . . . , and BMn. As a result, the information processing device 1 can easily acquire the basis maps BM1, BM1, BM2, . . . , and BMn for each of the plurality of purchase patterns, corresponding to the arrangement in the store for each product category, without measuring the movement of the user each time when the product arrangement is changed.

Furthermore, the information processing device 1 combines the basis maps BM1, BM1, BM2, . . . , and BMn based on the weight for each time band set based on the POS data 42 for each time band and generates the heatmap HM1 for each time band. As a result, the information processing device 1 can easily obtain the heatmap HM1 corresponding to the POS data 42 for each time band, without measuring the movement of the user in the store ST1 or reproducing the movement of the user by the agent simulation for each time band.

Note that it is not always necessary that each component of the each illustrated device is physically configured as illustrated in the drawings. For example, specific modes of distribution and integration of each device are not limited to those illustrated, and the whole or a part of the device may be configured by being functionally or physically distributed or integrated in any unit depending on various loads, use situations, and the like.

Furthermore, all or an optional part of various processing functions of the basis map generation unit 51, the weight setting unit 52, and the heatmap generation unit 53 executed by the control unit 50 of the information processing device 1 may be executed on a central processing unit (CPU) (or microcomputer such as micro processing unit (MPU) or micro controller unit (MCU)). Furthermore, it is needless to say that all or an optional part of various processing functions may be executed on a program analyzed and executed by a CPU (or microcomputer such as MPU or MCU) or on hardware by wired logic. Furthermore, various processing functions executed by the information processing device 1 may be executed by a plurality of computers in cooperation through cloud computing.

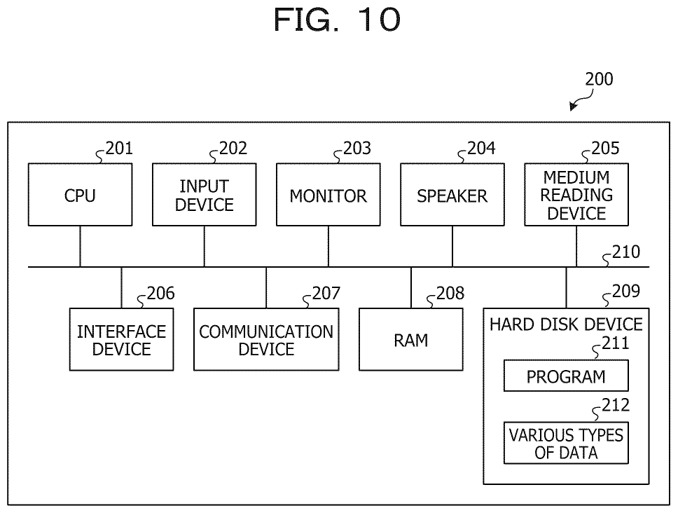

Meanwhile, various types of processing described in the embodiment above may be implemented by a computer executing a program prepared beforehand. Thus, hereinafter, an exemplary computer configuration (hardware) that executes a program having functions similar to the above embodiment will be described. FIG. 10 is an explanatory diagram explaining an example of a computer configuration.

As illustrated in FIG. 10, a computer 200 includes a CPU 201 that executes various type of arithmetic processing, an input device 202 that receives a data input, a monitor 203, and a speaker 204. Furthermore, the computer 200 includes a medium reading device 205 that reads a program or the like from a storage medium, an interface device 206 to be coupled to various devices, and a communication device 207 to be coupled to and communicate with an external device in a wired or wireless manner. Furthermore, the computer 200 also includes a random access memory (RAM) 208 that temporarily stores various types of information, and a hard disk device 209. Furthermore, each of the units (201 to 209) in the computer 200 is coupled to a bus 210.

A program 211 for executing various types of processing of the functional configurations (for example, basis map generation unit 51, weight setting unit 52, and heatmap generation unit 53) described in the above embodiment is stored in a hard disk device 209. Furthermore, the hard disk device 209 stores various types of data 212 that the program 211 refers to. The input device 202 receives, for example, an input of operation information from an operator. The monitor 203 displays, for example, various screens to be operated by the operator. For example, a printing device and the like are coupled to the interface device 206. The communication device 207 is coupled to a communication network such as a local area network (LAN), and exchanges various types of information with an external device via the communication network.

The CPU 201 reads the program 211 stored in the hard disk device 209 and develops and executes the program 211 on the RAM 208 so as to execute various types of processing related to the functional configuration (for example, basis map generation unit 51, weight setting unit 52, and heatmap generation unit 53) described above. Note that the program 211 does not have to be stored in the hard disk device 209. For example, the program 211 stored in a storage medium readable by the computer 200 may be read and executed. The storage medium readable by the computer 200 corresponds to, for example, a portable recording medium such as a compact disc read-only memory (CD-ROM), a digital versatile disc (DVD), or a universal serial bus (USB) memory, a semiconductor memory such as a flash memory, a hard disk drive, or the like. Furthermore, the program 211 may be prestored in a device coupled to a public line, the Internet, the LAN, or the like, and the computer 200 may read the program 211 from such a device to execute it.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a generation program for causing a computer to execute processing comprising:
setting a weight to each combination of product categories of purchased products, based on sales information of a product; and
generating visualized information that visualizes and indicates a behavior history of a user that corresponds to the sales information, by combining basis visualized information that visualizes and indicates a behavior history of the user in a store, for each of a plurality of purchase patterns that has different combinations of the product categories of the purchased products, stored in a memory, based on the set weight.

2. The non-transitory computer-readable recording medium according to claim 1, for causing a computer to execute processing further comprising:
generating the basis visualized information by simulating a movement of an agent that corresponds to the user in the store, for each of the plurality of purchase patterns, based on store information that indicates arrangement in the store for each product category.

3. The non-transitory computer-readable recording medium according to claim 1, wherein
the processing of generating the visualized information combines the basis visualized information based on the weight for each time band set based on the sales information for each time band and generates the visualized information for each time band.

4. A generation method comprising:
setting a weight to each combination of product categories of purchased products, based on sales information of a product; and
generating visualized information that visualizes and indicates a behavior history of a user that corresponds to the sales information by combining basis visualized information that visualizes and indicates a behavior history of the user in a store, for each of a plurality of purchase patterns that has different combinations of the product categories of the purchased products, stored in a memory, based on the set weight.

5. The generation method according to claim 4, for causing a computer to execute processing further comprising:
generating the basis visualized information by simulating a movement of an agent that corresponds to the user in the store, for each of the plurality of purchase patterns, based on store information that indicates arrangement in the store for each product category.

6. The generation method according to claim 4, wherein
the processing of generating the visualized information combines the basis visualized information based on the weight for each time band set based on the sales information for each time band and generates the visualized information for each time band.

7. An information processing device comprising:
a memory; and
a processor coupled to the memory and configured to:
set a weight to each combination of product categories of purchased products, based on sales information of a product; and
generate visualized information that visualizes and indicates a behavior history of a user that corresponds to the sales information by combining basis visualized information that visualizes and indicates a behavior history of the user in a store, for each of a plurality of purchase patterns that has different combinations of the product categories of the purchased products, stored in the memory, based on the set weight.

8. The information processing device according to claim 7, wherein the processor generates the basis visualized information by simulating a movement of an agent that corresponds to the user in the store, for each of the plurality of purchase patterns, based on store information that indicates arrangement in the store for each product category.

9. The information processing device according to claim 7, wherein
a process to generate the visualized information combines the basis visualized information based on the weight for each time band set based on the sales information for each time band and generates the visualized information for each time band.
